(19) United States
(12) Patent Application Publication
(10) Pub. No.: US 2026/0175836 A1
(43) Pub. Date: Jun. 25, 2026

(54) CONTROL DEVICE FOR AUTOMOBILE

(71) Applicant: Koito Manufacturing Co., Ltd., Tokyo (JP)

(72) Inventors: Tomoaki HARADA, Shizuoka-shi (JP); Takao MURAMATSU, Shizuoka-shi (JP)

(73) Assignee: Koito Manufacturing Co., Ltd., Tokyo (JP)

(21) Appl. No.: 19/540,936

(22) Filed: Feb. 16, 2026

Related U.S. Application Data
(63) Continuation of application No. PCT/JP2024/028550, filed on Aug. 8, 2024.

(30) Foreign Application Priority Data
Aug. 17, 2023 (JP) 2023-133006

(51) Int. Cl. B60W 30/095; B60Q 1/14

(52) U.S. Cl. CPC B60W 30/0956; B60Q 1/1423; B60Q 2300/112; B60R 2300/105

(57) ABSTRACT

A control device is to be mounted in an automobile equipped with a drive recorder and is modularized together with a camera of the drive recorder. The control device processes an image captured by the camera of the drive recorder and predicts a collision of the automobile with a preceding vehicle. In response to the prediction, the control device generates and outputs, to an external unit, a control signal that serves as a trigger for reducing brightness of a headlamp.

### CROSS-REFERENCE TO RELATED APPLICATIONS

This application is a continuation under 35 U.S.C. § 120 of International Application No. PCT/JP2024/028550, filed on Aug. 8, 2024, which claims priority to Japanese Patent Application No. 2023-133006, filed on Aug. 17, 2023. The entire contents of the foregoing applications are incorporated herein by reference in their entirety.

### BACKGROUND

### 1. Technical Field

The present disclosure relates to a lamp system for an automobile.

### 2. Description of the Related Art

Automobiles equipped with a drive recorder are increasing for the purpose of recording situations at the time of occurrence of a traffic accident, or recording dangerous acts such as tailgating. In addition, automobiles equipped with an advanced driver-assistance system (ADAS) are also increasing.

As a result of studying an automobile equipped with a drive recorder, the present inventor has come to recognize the following problems.

In a scene where an automobile collides with a preceding vehicle, the distance between the automobile and the preceding vehicle decreases, and thus the illuminance of a headlamp at the position of the preceding vehicle becomes extremely high. This may cause a license plate of the preceding vehicle to be washed out (whiteout) in an image recorded by the drive recorder.

### SUMMARY

The present disclosure has been made in view of such problems, and one exemplary object of one aspect thereof is to provide a system capable of recording important information of a subject even at the time of a collision.

One aspect of the present disclosure relates to a control device to be mounted in an automobile equipped with a drive recorder and modularized together with a camera of the drive recorder. The control device processes an image of the camera of the drive recorder, predicts a collision of the automobile with a preceding vehicle, and outputs, to an outside, a control signal that serves as a trigger for reducing brightness of a headlamp based on a result of the prediction.

Any combination of the above-described components, and any replacement of the components or expressions among methods, apparatuses, systems, and the like are also effective as aspects of the present disclosure. Furthermore, the above-described components do not describe all the essential features of the present disclosure, and therefore, a subcombination of these described features may also constitute the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures.

FIG. 1 is a block diagram of an automobile according to a first embodiment.

FIG. 2 is a block diagram of a microcontroller which is a camera ECU.

FIG. 3 is a flowchart of a headlamp control by the camera ECU.

FIG. 4 is a view for explaining an operation of a conventional lamp system.

FIG. 5 is a view for explaining an operation of the lamp system of FIG. 1.

FIG. 6 is a block diagram of an automobile according to a second embodiment.

FIG. 7 is a block diagram of an automobile according to a third embodiment.

### DETAILED DESCRIPTION

### Outline of Embodiments

An outline of several example embodiments of the disclosure follows. This outline is provided for the convenience of the reader to provide a basic understanding of such embodiments and does not wholly define the breadth of the disclosure. This outline is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A control device according to one embodiment is mounted in an automobile equipped with a drive recorder and is modularized together with a camera of the drive recorder. The control device processes an image of the camera of the drive recorder, predicts a collision of the automobile with a preceding vehicle, and outputs, to an outside, a control signal that serves as a trigger for reducing brightness of a headlamp based on a result of the prediction.

In this configuration, when the distance between the preceding vehicle and the host vehicle becomes short immediately before a collision, the brightness of the headlamp is reduced. As a result, the illuminance at the preceding vehicle is reduced, so that whiteout of an image recorded by the drive recorder can be prevented, and eventually, important information of a subject can be recorded at the time of the collision.

In one embodiment, the control device may predict the collision based on the image of the camera of the drive recorder. It is possible to estimate a distance to a subject based on a size of the subject appearing in the image of the camera, a change in the size, and the like, and the information obtained therein can be used for the prediction of the collision.

In one embodiment, the automobile may be equipped with a driving assistance system. The camera of the drive recorder may also serve as a sensor of the driving assistance system. By using the camera of the drive recorder also as the sensor of the driving assistance system, the cost for the functions can be reduced.

In one embodiment, the automobile may be equipped with a driving assistance system. The control device may predict the collision based on an output of a sensor of the driving assistance system. Examples of such a sensor include a millimeter-wave radar, LiDAR (Light Detection and Ranging), a ToF (Time of Flight) camera, a stereo camera, and a monocular camera.

In one embodiment, the control device may generate, based on the image of the camera of the drive recorder, light-shielding information for defining light distribution of the headlamp.

In one embodiment, the automobile may be equipped with a driving assistance system. The control device may generate, based on an output of a sensor of the driving assistance system, light-shielding information for defining light distribution of the headlamp.

A lamp system according to one embodiment includes a drive recorder and a headlamp. The drive recorder may include a camera and the control device described in any one of the above.

### EMBODIMENTS

Preferred embodiments will be explained below, referring to the attached drawings. All similar or equivalent constituents, members and processes illustrated in the individual drawings will be given same reference signs, so as to properly avoid redundant explanations. The embodiments are merely illustrative, and are not restrictive about the disclosure. All features and combinations thereof described in the embodiments are not always essential to the disclosure.

### First Embodiment

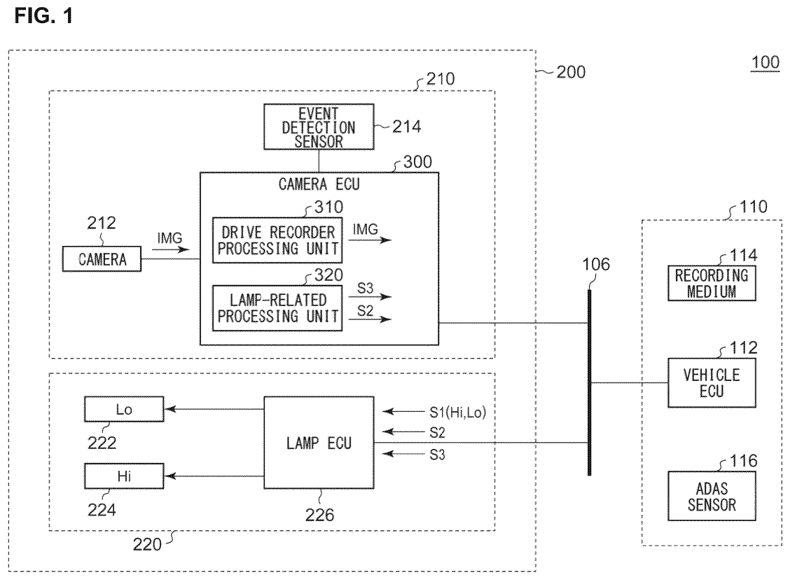

FIG. 1 is a block diagram of an automobile 100 according to a first embodiment. The automobile 100 includes a drive recorder 210, a headlamp 220, and a vehicle-side system 110. The drive recorder 210, the headlamp 220, and the vehicle-side system 110 are connected via a vehicle bus 106. The vehicle bus 106 may be a single bus or a plurality of buses. The type of the vehicle bus 106 is not particularly limited, but examples thereof include a CAN (Controller Area Network) and a LIN (Local Interconnect Network).

The drive recorder 210 captures an image of the front of the vehicle and records the captured image. In this example, a recording medium 114 is provided in the vehicle-side system 110. The recording medium 114 is an SD card, an SSD (Solid State Drive), a flash memory, or the like, and records an image generated by the drive recorder. In the block diagram of FIG. 1, the recording medium 114 is provided on the vehicle side, but it may be provided in the drive recorder 210.

The drive recorder 210 includes a camera 212, an event detection sensor 214, and a camera ECU 300.

The camera ECU 300 includes a drive recorder processing unit 310. The drive recorder processing unit 310 transfers image data IMG output from the camera 212 to the vehicle-side system 110. The event detection sensor 214 includes a gyro sensor, a gravity sensor, and the like. The drive recorder processing unit 310 detects a predetermined event, such as a large vibration, overturning, or rollover of a vehicle body, according to an output of the event detection sensor 214. Upon detecting an event, the drive recorder processing unit 310 switches a recording mode or the like.

The camera ECU 300 may be a control board configured by combining a microcontroller (MCU) and other hardware, and a processor executes various processes by executing a software program. Blocks shown inside the camera ECU 300 in the block diagram represent units of processes and functions implemented in the camera ECU 300 for convenience and schematically.

The headlamp 220 includes a low-beam unit 222, a high-beam unit 224, and a lamp ECU 226.

The lamp ECU 226 receives, from a vehicle ECU 112, an instruction signal S1 for turning on/off a low beam and a high beam. Upon receiving a low-beam turn-on instruction Lo, the lamp ECU 226 turns on the low-beam unit 222, and upon receiving a high-beam turn-on instruction Hi, the lamp ECU 226 turns on the high-beam unit 224.

The headlamp 220 may have an ADB function for adaptively controlling light distribution according to a target object in front of the vehicle. The high-beam unit 224 is a variable light distribution lamp and can provide a local light-shielding portion within a light distribution pattern. The lamp ECU 226 receives light-shielding information S2 from the vehicle-side system 110. The light-shielding information S2 includes data defining a region to be shielded from light within the light distribution. The lamp ECU 226 controls the high-beam unit 224 based on the light-shielding information S2 to illuminate the front of the vehicle with a glare-free high beam.

The drive recorder 210 includes the camera 212, the event detection sensor 214, and the control device 300. Hereinafter, the control device 300 is referred to as a camera electronic control unit (ECU). The camera ECU 300 is modularized together with the camera 212 of the drive recorder 210.

The vehicle-side system 110 includes the vehicle ECU 112 and the recording medium 114. The vehicle ECU 112 writes the image data IMG received from the drive recorder 210 into the recording medium 114.

The automobile 100 may be equipped with a driving assistance system, which can be implemented as a part of the vehicle-side system 110, and the vehicle-side system 110 includes an ADAS sensor 116. Examples of the ADAS sensor 116 include a millimeter-wave radar, LiDAR (Light Detection and Ranging), a ToF (Time of Flight) camera, a stereo camera, and a monocular camera. Alternatively, instead of or in addition to the ADAS sensor 116, the camera 212 of the drive recorder 210 may function as a sensor for ADAS.

Generally, a drive recorder 210 and a headlamp 220 are designed completely independently. However, the present embodiment is different from conventional ones in that the camera ECU 300 of the drive recorder 210 executes a part of processing related to the control of the headlamp 220. In other words, it can be said that the drive recorder 210 and the headlamp 220 form a lamp system 200.

The control of the headlamp 220 by the drive recorder 210 will be described below.

The camera ECU 300 includes a lamp-related processing unit (lamp-related function) 320. The lamp-related processing unit 320 predicts a collision of the automobile 100 equipped with the lamp system 200 with a preceding vehicle, and in response to the prediction, generates and outputs to the outside a control signal (dimming instruction) S3 that serves as a trigger for reducing the brightness of the headlamp 220.

The dimming instruction S3 is supplied to the lamp ECU 226 via the vehicle bus 106 or via other control lines not shown. In response to the dimming instruction S3, the lamp ECU 226 reduces the brightness of the lamps (222, 224) that are currently turned on.

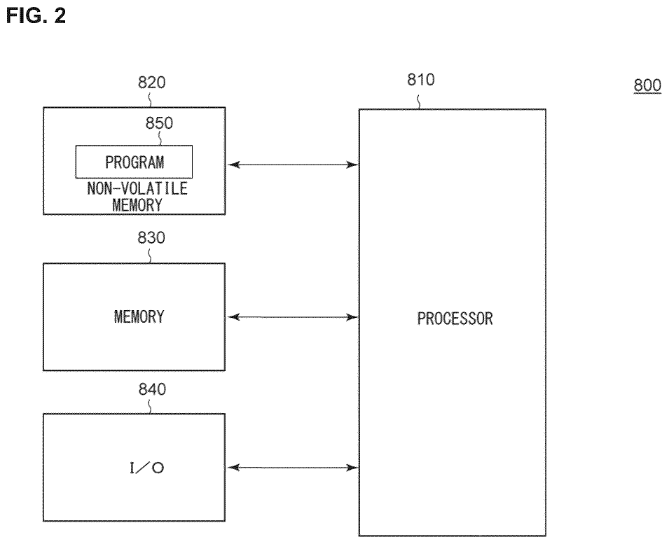

FIG. 2 is a block diagram of a microcontroller 800 which is the camera ECU 300. The microcontroller 800 includes a processor 810, a non-volatile memory 820, a memory 830, and an interface circuit 840. The non-volatile memory 820 is a flash memory and is a storage medium storing the above-described software program 850 executed by the processor 810. The processor 810 loads the software program 850 into the memory 830 at the time of startup and executes instructions of the software program 850. The interface circuit 840 may include a serial interface such as a UART (Universal Asynchronous Receiver and Transmitter), a 3-wire serial interface, or an I2C bus interface, a CAN interface, a GPIO, an A/D converter, a D/A converter, and the like. The components of the microcontroller 800 may be built in one IC package, or may be a microcomputer board in which several IC packages are mounted on a printed circuit board.

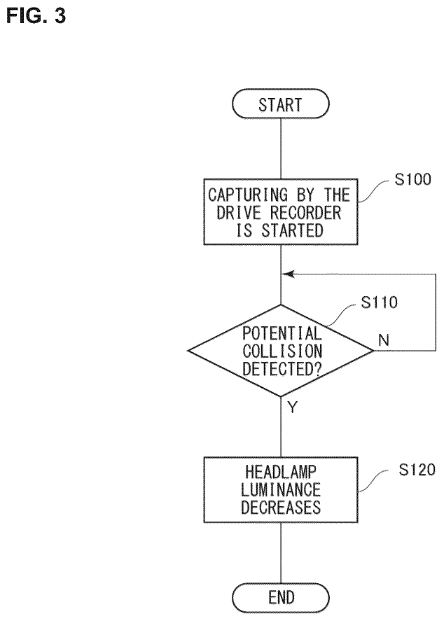

FIG. 3 is a flowchart of the control of the headlamp 220 by the camera ECU 300. Capturing by the drive recorder 210 is started (S100). The camera ECU 300 determines the possibility of a collision of the automobile 100 with a preceding vehicle (S110). If it is determined that the possibility of a collision is low (no) (N in S110), the determination of the possibility of a collision is continued. If it is determined that the possibility of a collision is high (yes) (Y in S110), a dimming instruction S3 is generated. In response to this dimming instruction S3, the brightness of the headlamp 220 is reduced (S120).

The above is the configuration of the lamp system 200.

Next, problems occurring in a headlamp system with a drive recorder will be described.

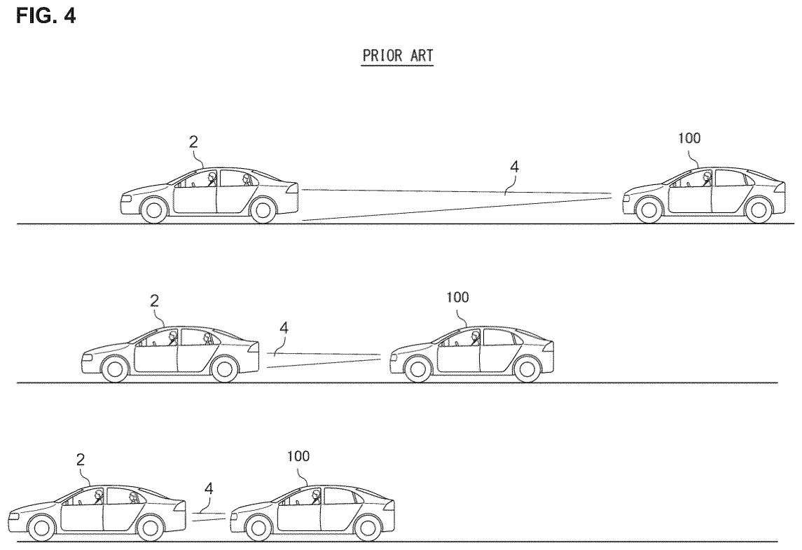

FIG. 4 is a view for explaining an operation of a conventional lamp system. FIG. 4 shows a driving scene immediately before a collision. Conventionally, a low beam 4 with constant brightness has been irradiated to a preceding vehicle 2 regardless of the distance to the preceding vehicle 2. In this case, as the distance to the preceding vehicle 2 decreases, the illuminance at the rear end surface of the preceding vehicle 2 increases, and the pixel values of the image of the preceding vehicle captured by the drive recorder increase, causing the preceding vehicle 2 to appear washed out. That is, important information such as a license plate to be recorded by the drive recorder may be missing.

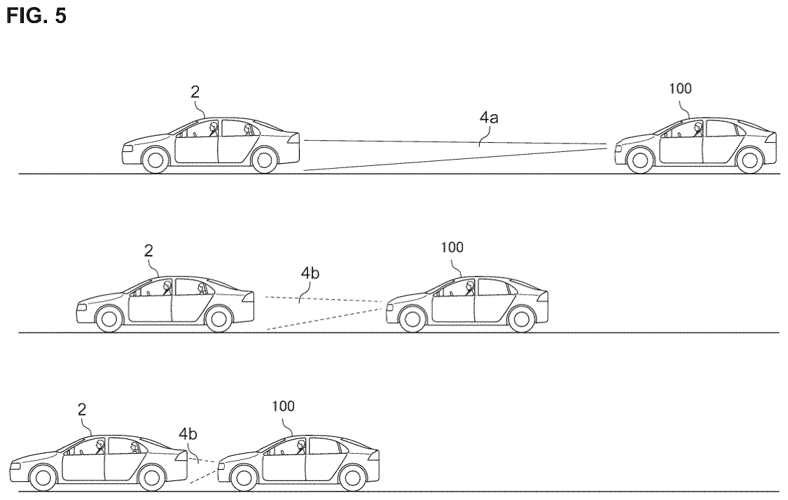

FIG. 5 is a view for explaining an operation of the lamp system of FIG. 1. The uppermost part of FIG. 5 shows a normal driving scene, in which the low-beam unit 222 emits light with a predetermined brightness, and a low beam 4a satisfying legal light distribution requirements is irradiated to the front of the vehicle.

As shown in the middle part of FIG. 5, when the distance to the preceding vehicle 2 decreases, the camera ECU 300 determines that the possibility of a collision with the preceding vehicle 2 has increased. Based on this determination, the light emission brightness of the low-beam unit 222 is reduced, and the low beam 4b becomes darker. Accordingly, at the moment of the collision shown in the lowermost part of FIG. 5, the illuminance at the preceding vehicle 2 becomes low, and therefore the pixel values of the image of the preceding vehicle captured by the drive recorder based on the reflected light thereof become smaller than those in FIG. 4. This suppresses whiteout and prevents the loss of important information such as a license plate.

In the present embodiment, the lamp-related processing unit 320 of the camera ECU 300 predicts a collision based on the image IMG of the camera 212. The camera ECU 300 can receive vehicle speed information from the vehicle ECU 112 via the vehicle bus 106. The lamp-related processing unit 320 can predict the collision based on the speed of the automobile 100 and the size of an object (preceding vehicle) appearing in the image IMG from the camera 212. Specifically, the camera ECU 300 can estimate a distance to the preceding vehicle based on the size of the preceding vehicle in the image IMG. Then, the collision may be predicted based on a relative relationship between the estimated distance and a stopping distance determined by the vehicle speed. In addition to or instead of the size of the object appearing in the image IMG, the distance to the object may be estimated based on a position where the object appears.

The method for predicting a collision is not limited thereto, and a known technology or a technology that will be available in the future may be used.

The lamp-related processing unit 320 may process the image IMG of the camera 212, determine the position and type of a target object in front of the vehicle, and generate the light-shielding information S2. That is, the camera 212 for the drive recorder may also serve as a sensor for ADB control. As a result, the cost of the lamp system 200 can be reduced.

One or both of the light-shielding information S2 and the dimming instruction S3 generated by the camera ECU 300 may be supplied from the vehicle ECU 112 to the lamp ECU 226 after passing through the vehicle ECU 112. Alternatively, one or both of the light-shielding information S2 and the dimming instruction S3 may be directly supplied from the camera ECU 300 to the headlamp 220.

### Second Embodiment

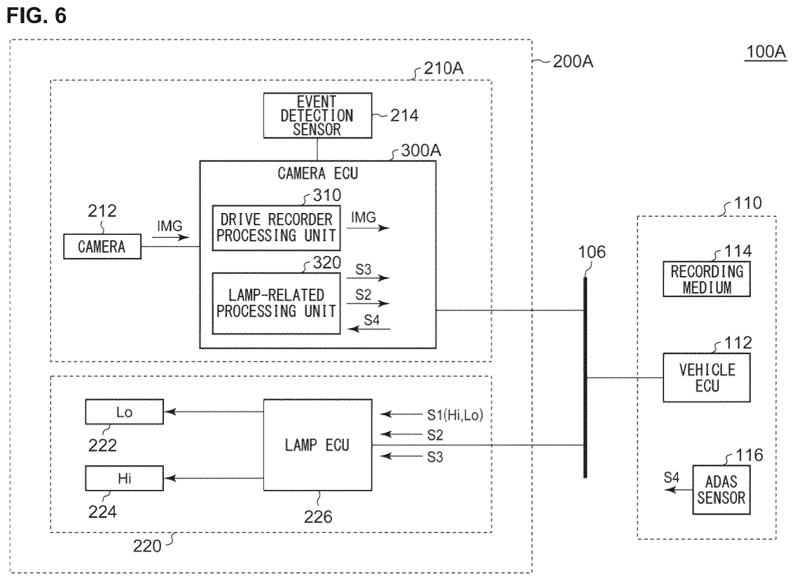

FIG. 6 is a block diagram of an automobile 100A according to a second embodiment. The processing of a lamp-related processing unit 320A of a camera ECU 300A in the second embodiment is different from that in the first embodiment. Specifically, the lamp-related processing unit 320A predicts a collision of the automobile 100A (host vehicle) with a preceding vehicle based on an output (sensor information) S4 of an ADAS sensor 116, instead of the image IMG generated by the camera 212.

Specifically, the sensor information S4 generated by the ADAS sensor 116 is supplied to the lamp-related processing unit 320A via the vehicle bus 106. The lamp-related processing unit 320A predicts the collision based on the sensor information S4, and generates a control signal (dimming instruction) S3 that is a trigger for reducing the brightness of the headlamp 220 when the possibility of the collision increases. Others are the same as those in the first embodiment.

According to the second embodiment, effects similar to those of the first embodiment can be obtained. In addition, by using the sensor information S4 generated by the ADAS sensor 116, the accuracy of the prediction of the collision can be improved.

### Third Embodiment

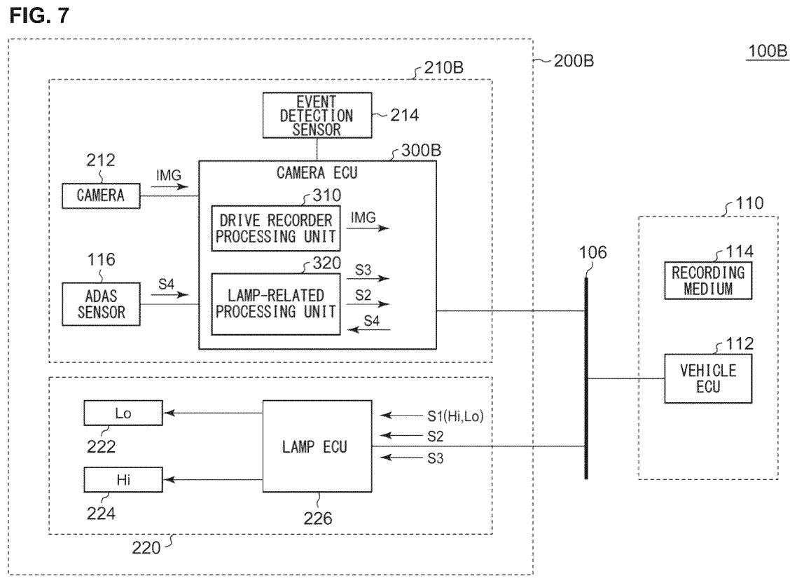

FIG. 7 is a block diagram of an automobile 100B according to a third embodiment. In the third embodiment, the ADAS sensor 116 is provided on the lamp system 200B side. For example, the ADAS sensor 116 may be built in a drive recorder 210B. Alternatively, the ADAS sensor 116 may be built in the headlamp 220.

The lamp-related processing unit 320B predicts the collision based on the sensor information S4 generated by the ADAS sensor 116 provided on the lamp system 200B side, and generates the control signal (dimming instruction) S3 that is a trigger for reducing the brightness of the headlamp 220 when the possibility of the collision increases. Others are the same as those in the second embodiment.

In the second and third embodiments, the lamp-related processing units 320A and 320B may predict the collision based on both the sensor information S4 and the image IMG generated by the camera 212.

### Modified Examples

In the first to third embodiments, the lamp-related processing unit 320, 320A, 320B may generate the light-shielding information S2 based on the sensor information S4 generated by the ADAS sensor 116.

The embodiments are exemplary, and it is understood by those skilled in the art that there are various modified examples in the combinations of the respective components and the respective treatment processes, and that such modified examples are also included in the scope of the present disclosure.

What is claimed is:

1. A control device to be mounted in an automobile equipped with a drive recorder, the control device being modularized together with a camera of the drive recorder, the control device configured to:
process an image captured by the camera of the drive recorder;
predict a collision of the automobile with a preceding vehicle; and
output, to an external unit, a control signal that serves as a trigger for reducing brightness of a headlamp based on a result of the prediction.

2. The control device according to claim 1, configured to predict the collision based on the image captured by the camera of the drive recorder.

3. The control device according to claim 2, wherein the automobile is equipped with a driving assistance system, and wherein the camera of the drive recorder also serves as a sensor of the driving assistance system.

4. The control device according to claim 1, wherein the automobile is equipped with a driving assistance system, and wherein the control device is configured to predict the collision based on an output of a sensor of the driving assistance system.

5. The control device according to claim 1, configured to generate, based on the image captured by the camera of the drive recorder, light-shielding information for defining light distribution of the headlamp.

6. The control device according to claim 1, wherein the automobile is equipped with a driving assistance system, and wherein the control device is configured to generate, based on an output of a sensor of the driving assistance system, light-shielding information for defining light distribution of the headlamp.

7. A lamp system comprising:
a drive recorder; and
a headlamp,
wherein the drive recorder includes:
a camera; and
the control device according to claim 1.

8. A program to be executed by a control device, the control device being mounted in an automobile equipped with a drive recorder and a driving assistance system, the control device being modularized together with a camera of the drive recorder, the program causing the control device to perform steps of:
processing an image captured by the camera of the drive recorder;
predicting a collision of the automobile with a preceding vehicle; and
outputting, to an outside of the control device, a control signal that is a trigger for reducing brightness of a headlamp based on a result of the prediction of the collision.
